(19) United States
(12) Patent Application Publication
(10) Pub. No.: US 2024/0073141 A1
(43) Pub. Date: Feb. 29, 2024

(54) Flow-based congestion control

(71) Applicant: MELLANOX TECHNOLOGIES, LTD., Yokneam (IL)

(72) Inventors: Niv Aibester, Herzliya (IL); Gil Levy, Hod Hasharon (IL); Yuval Shpigelman, Netanya (IL)

(21) Appl. No.: 17/895,108

(22) Filed: Aug. 25, 2022

(51) Int. Cl. H04L 47/12; H04L 47/30

(52) U.S. Cl. CPC H04L 47/12; H04L 47/30

(57) ABSTRACT

A network device includes multiple ports, a Shared Buffer (SB) and a SB controller. The ports to connect to a communication network. The SB to temporarily store packets received from the communication network via the ports, the packets belonging to multiple flows. The SB controller to allocate one or more flow-specific storage regions in the SB, a given flow-specific storage region being allocated to store the packets that (i) belong to respective one or more of the flows and (ii) are to be transmitted via a respective egress queue. In response to detecting that an occupancy level in the given flow-specific storage region exceeds a specified occupancy threshold, the SB controller to report the flows in the given flow-specific storage region as congested.

### TECHNICAL FIELD

Embodiments described herein relate generally to communication networks, and particularly to methods and systems for performing flow-based congestion control.

### BACKGROUND

Congestion management of packet traffic in communication systems is important for achieving high system performance such as throughput and latency. Moreover, persistent congestion may cause severe performance degradation, e.g., due to congestion spread.

Various techniques for detecting and controlling congestion are known in the art. For example, Ramakrishnan et al. describe congestion control techniques that use Explicit Congestion Notification (ECN), in a Request for Comments (RFC) 3168 of the Internet Engineering Task Force (IETF), entitled “The Addition of Explicit Congestion Notification (ECN) to IP,” September, 2001.

Switches used in high-speed networks such as Ethernet and InfiniBand, typically store incoming packets in a buffer memory until transmitted back to the network. Aspects of flexible usage of buffer space are described, for example, in U.S. Pat. No. 10,250,530 of Aibester et al., describing a communication apparatus that includes multiple interfaces configured to be connected to a packet data network for receiving and forwarding of data packets of multiple types. A memory is coupled to the interfaces and configured as a buffer to contain packets received through the ingress interfaces while awaiting transmission to the network via the egress interfaces. Packet processing logic is configured to maintain multiple transmit queues, which are associated with respective ones of the egress interfaces, and to place both first and second queue entries, corresponding to first and second data packets of the first and second types, respectively, in a common transmit queue for transmission through a given egress interface, while allocating respective spaces in the buffer to store the first and second data packets against separate, first and second buffer allocations, which are respectively assigned to the first and second types of the data packets.

### SUMMARY

An embodiment that is described herein provides a network device that includes multiple ports, a Shared Buffer (SB) and a SB controller. The ports to connect to a communication network. The SB to temporarily store packets received from the communication network via the ports, the packets belonging to multiple flows. The SB controller to allocate one or more flow-specific storage regions in the SB, a given flow-specific storage region being allocated to store the packets that (i) belong to respective one or more of the flows and (ii) are to be transmitted via a respective egress queue. In response to detecting that an occupancy level in the given flow-specific storage region exceeds a specified occupancy threshold, the SB controller to report the flows in the given flow-specific storage region as congested.

In some embodiments, the SB controller is to allocate a defined number of storage regions to a given egress queue, evaluate a number of distinct flows that are actually transmitted from the storage regions via the given egress port, calculate a load level for a certain storage region among the storage regions allocated to the given egress queue, based on an occupancy level in the certain storage region and on the number of distinct flows, and in response to detecting that the load level of the certain storage region exceeds a specified load threshold, to report the flows in the certain storage region as congested. In other embodiments, the SB is to distribute the flows among the defined number of the storage regions by applying a specified hash function to headers of the packets belonging to the flows. In yet other embodiments, the SB controller is to report the flows in the certain storage region as congested, by reporting (i) the load level calculated for the certain storage region and (ii) identifiers of the flows in the certain storage region.

In an embodiment, the SB controller is to report the flows in the given flow-specific storage region as congested, by sending one or more congestion notifications to respective destination nodes to which the packets in the given flow-specific storage region are addressed. In another embodiment, the SB controller is to mirror a congestion notification among the one or more congestion notifications to a remote analyzer node coupled to the communication network. In yet another embodiment, the SB controller is to report the flows in the given flow-specific storage region as congested, to respective source nodes from which the one or more flows originate.

In some embodiments, the SB controller is to report multiple flows among the flows in the given flow-specific storage region that are destined to a common destination node, by including respective identifiers of the multiple flows in a packet, and sending the packet to respective destination addresses of the flows or to respective source addresses of the flows.

There is additionally provided, in accordance with an embodiment that is described herein, a method, including, in a network device that connects to a communication network using multiple ports, temporarily storing packets received from the communication network via the ports in a Shared Buffer (SB) of the network device, the packets belonging to multiple flows. One or more flow-specific storage regions are allocated in the SB, a given flow-specific storage region being allocated to store the packets that (i) belong to respective one or more of the flows and (ii) are to be transmitted via a respective egress queue. In response to detecting that an occupancy level in the given flow-specific storage region exceeds a specified occupancy threshold, the flows in the given flow-specific storage region are reported as congested.

These and other embodiments will be more fully understood from the following detailed description of the embodiments thereof, taken together with the drawings in which:

### BRIEF DESCRIPTION OF THE DRAWINGS

FIG. 1 is a block diagram that schematically illustrates a computer system in which network devices perform flow-based congestion control, in accordance with an embodiment that is described herein;

FIG. 2 is a block diagram that schematically illustrates a switch handling flow-based congestion control using a shared buffer, in accordance with an embodiment that is described herein;

FIGS. 3A and 3B are diagrams that schematically illustrate example flow-based congestion control schemes, in accordance with embodiments that are described herein; and

FIG. 4 is a flow chart that schematically illustrates a method for congestion detection based on storage regions allocated to flows in a shared buffer, in accordance with an embodiment that is described herein.

### DETAILED DESCRIPTION OF EMBODIMENTS

### Overview

Embodiments that are described herein provide methods and systems for flow-based congestion control. In accordance with the disclosed embodiments, the detection of congested flows depends on occupancy levels in storage regions allocated to flows in a Shared Buffer (SB). Each storage region is mapped to one or more specific flows.

Various communication networks are built from multiple interconnected network devices such as routers or switches. A network device receives packets via multiple ports and stores the packets in a local buffer memory until transmitting them back to the network. In a shared buffer configuration, the storage space of the local buffer is shared among multiple physical ports of the switch. The storage space of the SB is typically handled by a SB controller within the switch.

The packets stored in the SB typically undergo various processing, including creating packet descriptors that are queued in Egress Queues (EQs) coupled to egress ports. In the disclosed embodiments, the SB controller allocates storage regions for (and based on) flows traversing the switch. Moreover, the SB controller maintains fairness in sharing SB resources among the flows. A storage region storing flows for which packets are not allowed to be dropped, may become overfilled, which indicates that at least some of the flows in that storage region are transmitted from their sources at high rates and may cause congestion in the switch. When the storage region is assigned to flows for which packets may dropped, the SB controller may drop packets in order to control overfilling.

The description that follows a network device refers mainly to network switch. The disclosed embodiments are similarly applicable, however, to other types of network devices that forward packets in a packet network such as routers.

Consider an embodiment of a network device (e.g., a switch) that includes multiple ports, a Shared Buffer (SB) and a SB controller. The ports connect to a communication network. The SB temporarily stores packets received from the communication network via the ports, the packets belonging to multiple flows. The SB controller allocates one or more flow-specific storage regions in the SB, wherein a given flow-specific storage region being allocated to store the packets that (i) belong to respective one or more of the flows and (ii) are to be transmitted via a respective egress queue. In response to detecting that an occupancy level in the given flow-specific storage region exceeds a specified occupancy threshold, the SB controller reports the flows in the given flow-specific storage region as congested. The SB controller may identify that the flows in the storage region are congested based on other and/or additional parameters such as, a load percentage in the storage region, a latency incurred by the switch in forwarding the flows in the storage region, and the like.

Each of the storage regions stores packets belonging to one or more flows. When the number of concurrent flows is relatively small, the SB controller may allocate storage regions as required. In this scheme, flows are mapped uniquely to storage regions based on flow identifiers carried in headers of the packets.

When the number of concurrent flows is very large, however, the SB may not have sufficient resources for managing as many storage regions, and the SB limits the number of storage regions allocated per EQ to a defined number. In this scheme, the SB controller calculates a load level for a certain storage region among the storage regions allocated to a given EQ, based on an occupancy level in the certain storage region and on a number of distinct flows actually transmitted from the certain storage region via the given EQ. In response to detecting that the load level of the certain storage region exceeds a specified load threshold, the SB controller reports the flows in the certain storage region as congested.

In embodiments in which the SB configuration supports a limited number of storage regions per EQ, the SB stores the received packets by distributing the flows to which they belong among the defined number of the storage regions. For example, the SB applies a specified hash function to headers of the packets, e.g., to a flow identifier in the headers. Assuming a number M of storage regions per EQ, the hash function has M possible outcomes, respectively associated with the M storage regions.

The SB controller may report flows as congested in various ways.

In some embodiments, the SB controller reports the flows in the given flow-specific storage region as congested, by sending one or more congestion notifications to respective destination nodes to which the packets in the given flow-specific storage region are addressed. The congestion notifications may be sent in-band, i.e., carried in headers of packets belonging to the flows (e.g., using ECN marking), or using dedicated packets. In an embodiment, the SB controller mirrors a congestion notification among the one or more congestion notifications to a remote analyzer node coupled to the communication network.

In some embodiments, for fast reaction to congestion, the SB controller reports the flows in the given flow-specific storage region as congested, directly to respective source nodes from which the one or more flows originate.

In some embodiments, the SB controller reports flows as congested by reporting each flow using a separate congestion notification. In alternative embodiments, the SB controller reports multiple flows among the flows in the given flow-specific storage region that are destined to a common destination node, by including respective identifiers of the multiple flows in a packet and sending the packet to respective destination addresses of the flows or to respective source addresses of the flows.

In embodiments in which the number of storage regions per EQ is limited, the SB controller may report the flows in a storage region as congested by reporting (i) the load level calculated for that storage region, and (ii) identifiers of the flows in the certain storage region (which are collectively indicative of the number of flows in the storage region.

In the disclosed techniques, a SB controller allocates storage regions in a shared buffer, to flows associated with a common egress queue. Based on occupancy levels in the storage regions, the SB controller may identify a congested storage region and report the flows in that storage region as congested. In other words, the SB reports any flow traversing this storage region as a flow that has passed through a congested storage region. A destination node reported of a congested flow, can send a suitable notification to the source node from which the flow originates, indicating the source node to reduce transmission rate of this flow. For example, the destination node may send to the source node a “PAUSE” message to stop transmission.

Using the disclosed techniques allows source nodes to quickly react to reported congested flows with reducing transmission rate into the network so as to prevent or resolve congestion events. Since the disclosed techniques result in reducing transmission rates of relevant flows that are likely to cause congestion, high throughput, low latency, and high network utilization are achieved concurrently.

### System Description

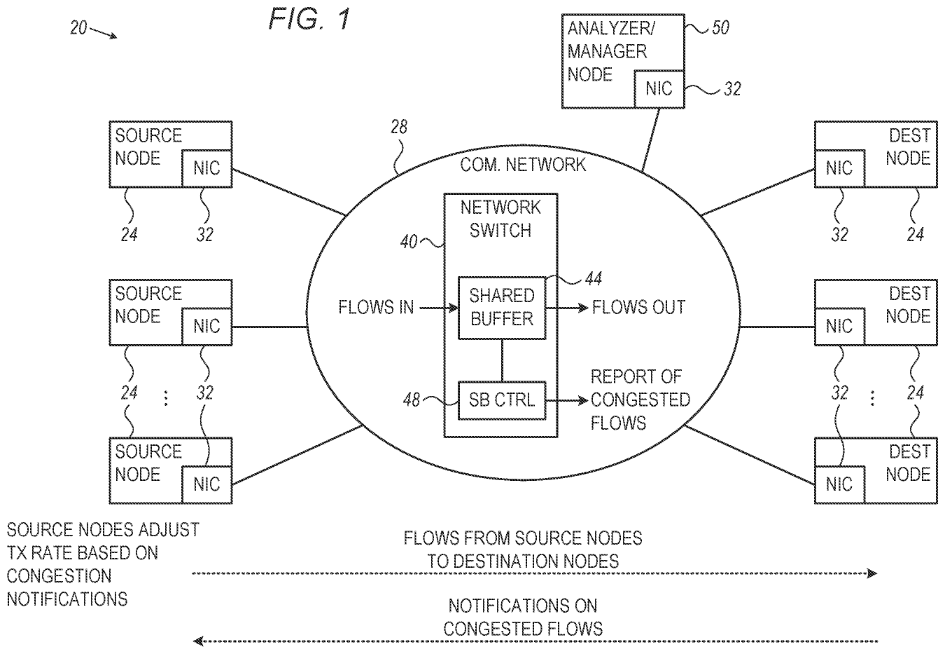

FIG. 1 is a block diagram that schematically illustrates a computer system 20, in which network devices perform flow-based congestion control, in accordance with an embodiment that is described herein.

Computer system 20 comprises multiple network nodes 24 communicating with one another over a communication network 28. The network nodes connect to the communication network using any suitable network interface such a Network Interface Controller (NIC) 32.

Communication network 28 may comprise any suitable type of a communication network, operating using any suitable communication protocols. For example, communication network 28 may comprise an Ethernet network in which packets are communicated using the Transmission Control Protocol (TCP) and the Internet Protocol (IP). As another example, communication network 28 may comprise an InfiniBand™ fabric. Communication over network 28 may be based, for example, on the Remote Direct Memory Access (RDMA) over Converged Ethernet (RoCE) protocol, which is a RDMA protocol (implementing an InfiniBand transport layer) over IP and Ethernet. As another example, communication over network 28 may be based on the NVLink® protocol by Nvidia.

Computer system 20 may be used, for example, in high-rate communication applications such as, for example, in High-Performance Computing (HPC) environments, data centers, storage networks, Artificial Intelligence (AI) clusters, and in providing cloud services.

Communication network 28 comprises multiple interconnected network devices 40 such as switches or routers. For the sake of clarity, FIG. 1 depicts only one network device comprising a switch. Switch 40 comprises a SB 44 managed by a SB controller 48. Other switches in communication network 28 (not shown) may also comprise a SB and a SB controller.

In the example of FIG. 1, network nodes 24 depicted on the left side of the figure serve as source nodes sending packets to destination nodes depicted on the right side. In the present context, the term “flow” refers to a sequence of packets sent from a source node to a destination node. Each source node may send over communication network 28 one or more flows, and each destination node may receive from the communication network one or more flows.

In some applications, computer system 20 may be required to communicate many flows concurrently, some of which may carry high data rate traffic. In such a scenario, switch 40 may be overwhelmed by the amount of incoming traffic and become congested. The overall number of concurrent flows may range, for example, between a thousand and several million flows. Typically, each flow is associated with an application program running, e.g., on a host. The application program may communicate with other application programs in the same host or in other hosts. An application program may also serve as a distributed application program that is distributed across many hosts communicating with one another.

In the present context, “congested storage regions” are identified based on their respective occupancy levels. Moreover, a flow in a congested storage region is considered as a “congested flow.” It is noted that a congested flow is likely to cause congestion and therefore its transmission rate at the source node should be reduced.

In some embodiments, switch 40 manages congestion detection using SB controller 48. The SB controller allocates storage regions to incoming flows and monitors the occupancy levels in these storage regions for detecting congested storage regions. The SB reports flows in congested storage regions to their destination nodes, which in turn send congestion notifications indicative of the congested flows to the source nodes from which they originate. In response to the congested notifications, the source nodes reduce the transmission rates of the reported flows to resolve the congestion or preventing imminent congestion.

In some embodiments, computer system 20 comprises an analyzer/manager node 50 coupled to communication network 28. The analyzer/manager node uses for network configuration and analysis. The analyzer/manager receives information from switches 40 and displays the information and/or configures the switches based on the information. In some embodiments, the analyzer/manager runs an Artificial Intelligence (AI) process as a background process, so as to analyze the behavior of application programs, and configure these application programs as required. The AI process may represent, for example, what metrics are more important than others. In an embodiment, switch 40 reports congested flows to the analyzer/manager, e.g., using mirroring techniques. The analyzer/manager may notify relevant source nodes to reduce transmission rate, based on the congested flows reported by switches 40.

### Switch Architecture Supporting Flow-Based Congestion Control

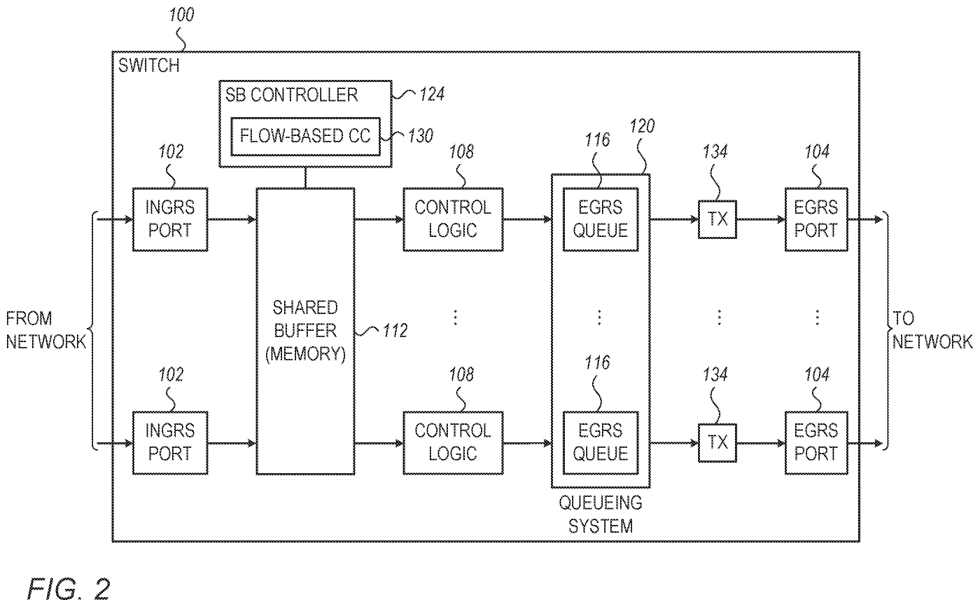

FIG. 2 is a block diagram that schematically illustrates a switch 100 handling flow-based congestion control using a shared buffer, in accordance with an embodiment that is described herein.

Switch 100 may be used, for example, in implementing switch 40 of FIG. 1.

Switch 100 comprises interfaces in the form of ingress ports 102 and egress ports 104 for connecting to communication network 28. Switch 100 receives packets from the communication network via ingress ports 102 and transmits forwarded packets via egress ports 104. Although in FIG. 2, the ingress ports and egress ports are separated, in practice, each port may serve both as an ingress port and as an egress port.

Each ingress port 102 is associated with respective control logic 108 that processes incoming packets as will be described below. Although FIG. 2 depicts only two control logic modules 108, a practical switch may comprise hundreds ingress ports and corresponding control logic modules. A memory 112, coupled to ingress ports 102, is configured as a shared buffer for temporarily storing packets that are processed and assigned to multiple egress queues (described below) for transmission to the communication network.

In some embodiments, upon receiving an incoming packet via an ingress port 102, the ingress port places the packet in shared buffer 112 and notifies relevant control logic 108 that the packet is ready for processing. Control logic 108 applies to the packet various processing such as parsing the packet header(s) and generating for the packet a descriptor. Based on the descriptor, the control logic typically determines an egress port 104 through which the packet is to be transmitted. The descriptor may also indicate the quality of service (QoS) to be applied to the packet, i.e., the level of priority at reception and for transmission, and any applicable instructions for modification of the packet header. The control logic may also decide on whether to drop or admit the packet.

Control logic 108 places the descriptors of admitted packets in the appropriate Egress Queues (EQs) 116 in a queueing system 120, to await transmission via the designated egress ports 104. Typically, queuing system 120 contains a dedicated EQ for each egress port 104 or multiple EQs per egress port, one for each QoS level (e.g., transmission priority).

Control logic 108 passes the descriptors of admitted packets to queueing system 120 and to a shared buffer (SB) controller 124, which serves as the central buffer management and accounting module for shared buffer 112. SB controller 124 receives consumption information in response to control logic 108 deciding to admit a packet and receives release information in response to transmitting a queued packet. SB controller 124 allocates storage regions for incoming flows and maps the flows to the storage regions in the control plane. While the switch communicating flows, the SB controller monitors occupancy levels in storage regions based on the consumption and release information. In some embodiments, SB controller 124 comprises a flow-based Congestion Control (CC) module 130, which based on the monitored storage regions detects congested storage regions containing congested flows. Methods for detecting and reporting congested storage regions (that contain congested flows) will be described in detail below.

When a descriptor of a packet queued in queueing system 120 reaches the head of its queue, the queuing system passes the descriptor to a packet transmitter 134 coupled to a respective egress port 104, for execution. In response to the descriptor, packet transmitter 134 reads the packet data from shared buffer 112, and (optionally) makes whatever changes are called for in the packet header for transmission to communication network 28 through egress port 104.

The computer system configuration of FIG. 1 and the switch configuration of FIG. 2 are given by way of example, and other suitable computer system and switch configurations can also be used.

Some elements of switch 100, such as control logic 108 and SB controller 124 may be implemented in hardware, e.g., in one or more Application-Specific Integrated Circuits (ASICs) or Field-Programmable Gate Arrays (FPGAs). Additionally or alternatively, some elements of the switch can be implemented using software, or using a combination of hardware and software elements.

Elements that are not necessary for understanding the principles of the present application, such as various interfaces, addressing circuits, timing and sequencing circuits and debugging circuits, have been omitted from FIG. 2 for clarity.

Memory 112 implementing the SB may comprise any suitable storage device using any suitable storage technology, such as, for example, a Random Access Memory (RAM).

In some embodiments, some of the functions of SB controller 124 may be carried out by a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Shared Buffer Congestion Control Schemes

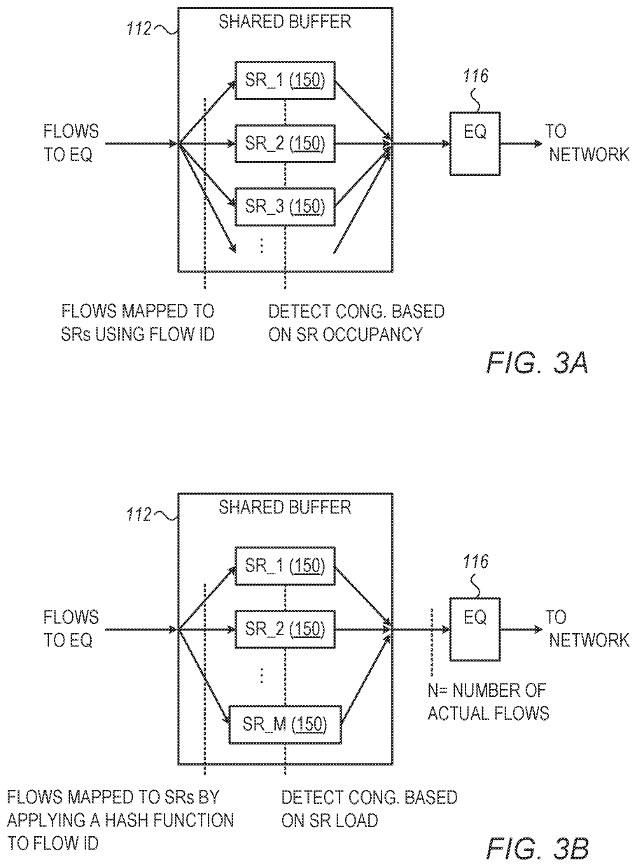

FIGS. 3A and 3B are diagrams that schematically illustrate example flow-based congestion control schemes, in accordance with embodiments that are described herein.

In managing congestion control, SB controller 124 allocates Storage Regions (SRs) 150 within SB 112. Each of the allocated SRs may stores packets (or payload data of the packets) belonging to one or more flows. The SB controller allocates separate respective groups of one or more SRs to flows that are forwarded to different EQs. In some embodiments, the SB controller maintains fairness among all active groups. Each of the groups aggregates several SRs and is mapped to a storage pool. FIGS. 3A and 3B depict one group of SRs 150 allocated to flows that are destined to a common EQ 116.

In describing storage region allocation, consider a source node establishing a connection with a destination node for sending a given flow from the source node to the destination node over communication network 28. It is further assumed that the packets of given flow traverse a switch in the network such as switch 100 of FIG. 2.

In some embodiments, in response to establishing the connection, SB controller 124 associates the given flow with one of the SRs 150 already allocated in SB 112 or allocates for the given flow a new SR in SB 112. The new SR typically belongs to some storage pool. When the connection of the given flow terminates and no other flows are associated with the SR of the given flow, the SB controller releases the storage space of this SR back to the storage pool.

In some embodiments, the SRs allocated by SB controller 124 to flows destined to a given EQ occupy the same storage space (a common SR size). In other embodiments, the SB controller allocates SRs of different sizes to at least two flows destined to the given EQ. In some embodiments, the SR size is determined depending on flow priority. In such embodiments, the SB controller may allocate to a high priority SR a larger storage space, compared to a low priority SR.

In the embodiment of FIG. 3A, the SB controller allocates SRs as required. In this case, flows are stored in the SB by mapping the flows to SRs using flow identifiers. A flow identifier may comprise, for example, a five-tuple carried in the packet header, including source and destination addresses and ports, and a protocol. Flow-based CC 130 monitors the occupancy levels in the SRs and detects a congested SR when the occupancy level of the SR exceeds an occupancy threshold. Upon detecting that a given SR is congested, flow-based CC 130 reports the flows in the given SR as congested.

In the embodiment of FIG. 3B, the overall number of SRs per EQ is limited to a positive integer denoted ‘M’. In this embodiment the SB controller allocates M SRs for each EQ. In this scheme, the SB stores incoming flows by applying a suitable hash function to the flow identifier. The hash function has M outcomes associated respectively with the M SRs. Flow-based CC 130 monitors load levels in the M SRs, and detects a congested SR when the load level of the SR exceeds a load threshold. Upon detecting that a given SR is congested, flow-based CC 130 reports the flows in the given SR as congested. To calculate the load level of a SR, the SR controller estimates (e.g., using flow-based CC 130) the number of flows (denoted ‘N’) that are actually transmitted from the M SRs to the EQ in question. The SR controller calculates the load level as: (occupancy level in SR) M/N. On average, the flows mapped to the M SRs have the same load level.

SB controller 124 may report congested flows in various ways. In some embodiments, the SB controller reports the flows in a given storage region as congested, by sending one or more congestion notifications to respective destination nodes to which the packets in the given storage region are addressed.

In one embodiment, the SB controller reports each of the congested flows separately, e.g., by sending an Explicit Congestion Notification (ECN) to the relevant destination node in a header of a packet belonging to the flow, e.g., in accordance with RFC 3168 cited above. In another embodiment, the SB controller reports multiple congested flows that are forwarded to the same destination node in a common congestion notification that the SB controller sends to that destination node.

In an embodiment, in reporting multiple flows as congested, the SB controller includes respective identifiers of the multiple flows in a packet and sends the packet to respective destination addresses of the flows or to respective source addresses of the flows.

In some embodiments, the SB controller reports the flows in a given SR as congested, to respective source nodes from which the one or more flows in the given SR originate. Such embodiments result in fast reaction to a congestion condition in the network.

In embodiments in which the number of SRs per EQ is limited to M as depicted in FIG. 3B, the SB controller may report the flows in a given SR as congested, by sending to the relevant destination nodes notifications indicative of (i) the load level of the given SR and (ii) identifiers of the flows in the given SR. The SB may send the notifications in band, i.e., within the packets of the flow, or using dedicated packets. A destination node receiving a notification of a load level, may decide to send a congestion notification to relevant source nodes.

### Methods for Congestion Detection

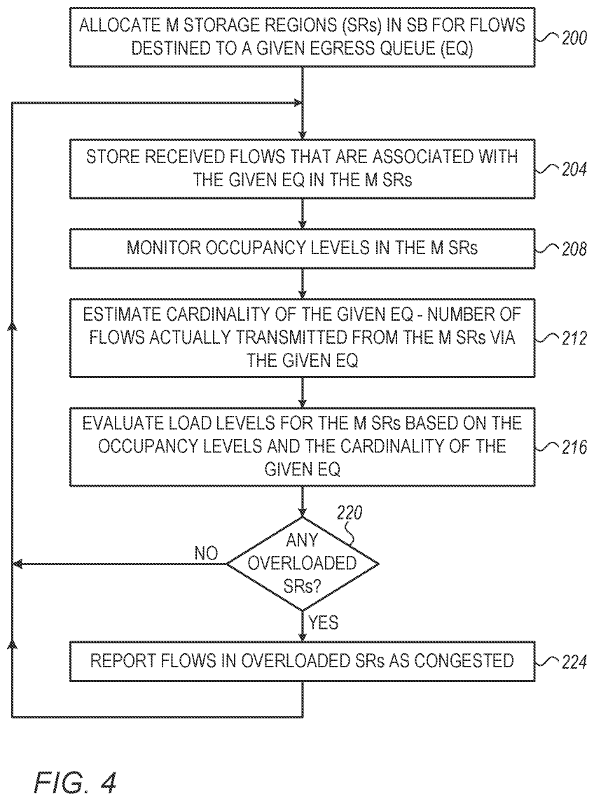

FIG. 4 is a flow chart that schematically illustrates a method for congestion detection based on storage regions allocated to flows in a shared buffer, in accordance with an embodiment that is described herein.

The method will be described as executed by various elements of switch 100 of FIG. 2.

The method begins at a storage allocation step 200, with SB controller 124 allocating M Storage Regions (SRs) in SB 112 for incoming flows that are destined to a given EQ 116. At a reception step 204, SB 112 receives incoming flows via ingress ports 102. SB 112 stores packets (or payload data of the packets) of those flows among the received flows that are destined to the given EQ, in the M SRs allocated for the given EQ. SB 112 maps the flows to respective SRs by applying a hash function to a flow identifier in the packet header, wherein the hash function has M different outcomes corresponding to M SRs.

At a monitoring step 208, flow-based CC 130 of the SB controller monitors the occupancy levels of the M SRs. At a cardinality estimation step 212, the flow-based CC estimates the cardinality of the given EQ, the cardinality being the number of flows actually transmitted from the M SRs via the given EQ. At a load evaluation step 216, the flow-based CC evaluates M load levels corresponding to the M SRs based on occupancy levels of the SRs and on the cardinality of the given EQ. Specifically, for the i^{th} SR, i=1 . . . M, having a respective occupancy level denoted OL (i), the flow-based CC calculates the load as given by:

Load[SR(i)]=OL(i)·M/N. Equation 1:

At a congestion checking step 220, the flow-based CC checks whether any of the M SRs is overloaded, i.e., its load level exceeding a load threshold, and if so, the SB controller identifies such SR(s) as congested and reports the flows in such SR(s) as congested, at a congestion reporting step 224. When at step 220, no congested SR has been detected, or following step 224, the method loops back to step 204 to receive more flow traffic.

The embodiments described above are given by way of example, and alternative suitable embodiments can also be used.

It will be appreciated that the embodiments described above are cited by way of example, and that the following claims are not limited to what has been particularly shown and described hereinabove. Rather, the scope includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network device, comprising:
multiple ports, to connect to a communication network;
a Shared Buffer (SB), to temporarily store packets received from the communication network via the ports, the packets belonging to multiple flows; and
a SB controller, to:
allocate one or more flow-specific storage regions in the SB, wherein a given flow-specific storage region being allocated to store the packets that (i) belong to respective one or more of the flows and (ii) are to be transmitted via a respective egress queue; and
in response to detecting that an occupancy level in the given flow-specific storage region exceeds a specified occupancy threshold, report the flows in the given flow-specific storage region as congested.

2. The network device according to claim 1, wherein the SB controller is to:
allocate a defined number of storage regions to a given egress queue;
evaluate a number of distinct flows that are actually transmitted from the storage regions via the given egress port;
calculate a load level for a certain storage region among the storage regions allocated to the given egress queue, based on an occupancy level in the certain storage region and on the number of distinct flows; and
in response to detecting that the load level of the certain storage region exceeds a specified load threshold, report the flows in the certain storage region as congested.

3. The network device according to claim 2, wherein the SB is to distribute the flows among the defined number of the storage regions by applying a specified hash function to headers of the packets belonging to the flows.

4. The network device according to claim 2, wherein the SB controller is to report the flows in the certain storage region as congested, by reporting (i) the load level calculated for the certain storage region and (ii) identifiers of the flows in the certain storage region.

5. The network device according to claim 1, wherein the SB controller is to report the flows in the given flow-specific storage region as congested, by sending one or more congestion notifications to respective destination nodes to which the packets in the given flow-specific storage region are addressed.

6. The network device according to claim 5, wherein the SB controller is to mirror a congestion notification among the one or more congestion notifications to a remote analyzer node coupled to the communication network.

7. The network device according to claim 1, wherein the SB controller is to report the flows in the given flow-specific storage region as congested, to respective source nodes from which the one or more flows originate.

8. The network device according to claim 1, wherein the SB controller is to report multiple flows among the flows in the given flow-specific storage region that are destined to a common destination node, by including respective identifiers of the multiple flows in a packet, and sending the packet to respective destination addresses of the flows or to respective source addresses of the flows.

9. A method, comprising:
in a network device that connects to a communication network using multiple ports,
temporarily storing packets received from the communication network via the ports in a Shared Buffer (SB) of the network device, the packets belonging to multiple flows;
allocating one or more flow-specific storage regions in the SB, wherein a given flow-specific storage region being allocated to store the packets that (i) belong to respective one or more of the flows and (ii) are to be transmitted via a respective egress queue; and
in response to detecting that an occupancy level in the given flow-specific storage region exceeds a specified occupancy threshold, reporting the flows in the given flow-specific storage region as congested.

10. The method according to claim 9, and comprising allocating a defined number of storage regions to a given egress queue, evaluating a number of distinct flows that are actually transmitted from the storage regions via the given egress port, calculating a load level for a certain storage region among the storage regions allocated to the given egress queue, based on an occupancy level in the certain storage region and on the number of distinct flows, and, in response to detecting that the load level of the certain storage region exceeds a specified load threshold, reporting the flows in the certain storage region as congested.

11. The method according to claim 10, and comprising distributing the flows among the defined number of the storage regions by applying a specified hash function to headers of the packets belonging to the flows.

12. The method according to claim 10, wherein reporting the flows in the certain storage region as congested, comprises reporting (i) the load level calculated for the certain storage region and (ii) identifiers of the flows in the certain storage region.

13. The method according to claim 9, wherein reporting the flows in the given flow-specific storage region as congested, comprises sending one or more congestion notifications to respective destination nodes to which the packets in the given flow-specific storage region are addressed.

14. The method according to claim 13, and comprising mirroring a congestion notification among the one or more congestion notifications to a remote analyzer node coupled to the communication network.

15. The method according to claim 9, wherein reporting the flows in the given flow-specific storage region as congested comprises reporting the flows in the given flow-specific storage region as congested to respective source nodes from which the one or more flows originate.

16. The method according to claim 9, wherein reporting the flows in the given flow-specific storage region comprises reporting multiple flows among the flows in the given flow-specific storage region that are destined to a common destination node, by including respective identifiers of the multiple flows in a packet, and sending the packet to respective destination addresses of the flows or to respective source addresses of the flows.
